(19) United States
(12) Patent Application Publication
(10) Pub. No.: US 2009/0314866 A1
(43) Pub. Date: Dec. 24, 2009

(54) ROLLER MILL

(76) Inventors: Dirk Hoffmann, Trippstadt (DE); Otto Jung, Huetschenhausen (DE); Karl-Heinz Schuette, Trippstadt (DE); Hardy Lessmeister, Kaiserslautern (DE); Ralf Frankenberger, Kaiserslautern (DE)

Correspondence Address: Muncy, Geissler, Olds & Lowe, PLLC, P.O. BOX 1364, FAIRFAX, VA, 22038-1364, US

(21) Appl. No.: 12/489,170

(22) Filed: Jun. 22, 2009

Related U.S. Application Data
(63) Continuation of application No. PCT/EP2007/010696, filed on Dec. 8, 2007.

(30) Foreign Application Priority Data
Dec. 22, 2006 (DE) 102006061328.7

(51) Int. Cl. B02C 15/04; B02C 23/00

(52) U.S. Cl. 241/120; 241/285.3

(57) ABSTRACT

A roller mill is provided that includes a housing, a grinding plate with a drive, and grinding rollers which roll down on the grinding plate, wherein rockers and rocker axes are provided for each grinding roller, as well as tensioning devices having hydraulic cylinders for pressing the grinding rollers onto the grinding plate. A swivel device having a swivel axis is provided for each grinding roller. The hydraulic cylinders are capable of swiveling the grinding rollers out of the housing. The grinding rollers are mounted next to the mill housing on consoles, and the hydraulic cylinders are located next to the consoles.

This nonprovisional application is a continuation of International Application No. PCT/EP2007/010696, which was filed on Dec. 8, 2007, and which claims priority to German Patent Application No. DE 102006061328.7, which was filed in Germany on Dec. 22, 2006, and which are both herein incorporated by reference.

### BACKGROUND OF THE INVENTION

1. Field of the Invention

The invention relates to roller mills, which can include a housing, a grinding table with a drive, grinding rollers that roll on the grinding table, rockers and rocker axes for each grinding roller, and/or clamping devices with hydraulic cylinders for pressing the grinding rollers against the grinding table.

2. Description of the Background Art

Roller mills are subject to more or less considerable wear. The grinding rollers and grinding track are especially affected. If these parts need to be maintained or repaired, the grinding rollers must, as a general rule, be removed from the grinding chamber. The mill manufacturers and operators use special handling devices for this purpose that are adapted to the particular mill type. These may be carriage-like devices, craneways routed into the interior of the mill, or also hydraulic auxiliary devices. In some cases, the grinding rollers must be removed completely from their roller guides to permit disassembly. In other designs, the roller guide and clamping cylinder must be separated so as to be able to swivel the rollers out of the housing with auxiliary cylinders. DE 10 2004 062 400 A, which corresponds to U.S. Publication NO. 20080041990, illustrates a conventional roller mill.

Because the grinding rollers and their supporting and clamping devices may weigh several tens of tons, the auxiliary devices required must be appropriately large in size. The handling of these auxiliary devices and the manipulation of the grinding rollers is difficult and time-consuming on account of their great weight. This is unsatisfactory.

### SUMMARY OF THE INVENTION

It is therefore an object of the present invention to provide a roller mill in which the grinding rollers can be swung out of the mill housing in a simple and rapid manner.

In an embodiment, a roller mill is provided that includes a swivel device with a swivel axis is provided for each grinding roller, whereby hydraulic cylinders of the clamping devices are capable of swiveling the grinding rollers out of the housing.

Thanks to the use of hydraulic cylinders that not only can clamp the grinding and raise them from the grinding track, but can also swivel the entire grinding rollers out of the housing, all auxiliary devices needing to be attached and removed are eliminated. All that is necessary is to provide a swivel axis, wherein in a particular embodiment of the invention the rocker axis that is active during grinding operation can also take on the function of the swivel axis.

The grinding rollers can be supported on brackets that stand next to the mill housing. Thanks to this design, the mill housing is not loaded by the grinding forces.

In order to improve the options for motion of the grinding rollers, in particular with regard to swiveling them out of the housing, the hydraulic cylinders are preferably positioned adjacent to the brackets, and not between the bracket and mill housing as in the aforementioned prior art.

If the rocker axis and swivel axis are separate, they are oriented perpendicular to one another according to one embodiment of the invention. This simplifies the design implementation of the swiveling.

According to a preferred embodiment of the invention, removable connections are provided that alternately lock one of the axes. This ensures that the grinding rollers execute the desired motion in each case.

According to a further development thereof, a removable connecting rod is provided to lock the rocker axis and/or to limit the travel of the grinding rollers. By means of a suitable geometry of this connecting rod, it is possible to lock the rocker axis in every desired position. This is especially advantageous when the grinding rollers either are raised from the grinding track during partial load operation of the mill or are swiveled out of the mill housing.

According to another embodiment of the invention, screws are provided to lock the swivel axis. Such a screw connection can be employed without disadvantage, since the grinding rollers are fully swiveled only rarely.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a roller mill with rocker axis and separate swivel axis during grinding operation in an isometric view,

FIG. 2 shows the roller mill from FIG. 1 during maintenance with grinding rollers partially swiveled out,

FIG. 3 shows the roller mill from FIGS. 1 and 2 with grinding rollers fully swiveled out,

FIG. 4 shows an enlarged cross-sectional view of the region of the rockers, and

FIG. 5 shows a cross section through a roller mill with only one axis.

### DETAILED DESCRIPTION

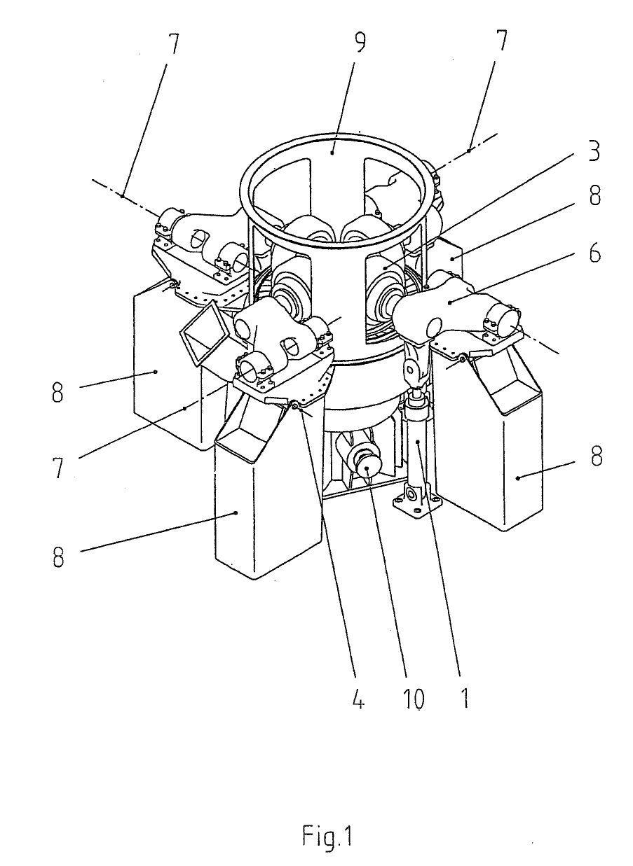

FIGS. 1 to 3 show a first roller mill with a mill housing 9, in which a grinding track 2 is rotatably mounted. The grinding track 2 is driven by a drive 10. Four grinding rollers 3 are supported on rockers 6, which have a rocker axis 7. The rockers 6 are engaged by hydraulic cylinders 1, with the aid of which the grinding rollers 3 are pressed with defined force against the grinding track 2 and the grinding stock lying thereon during grinding. In this regard, the grinding rollers oscillate about the rocker axes 7.

As is shown in FIGS. 1 to 3, the grinding rollers 3 and the rockers 6 are positioned on brackets 8, which stand adjacent to the mill housing 9.

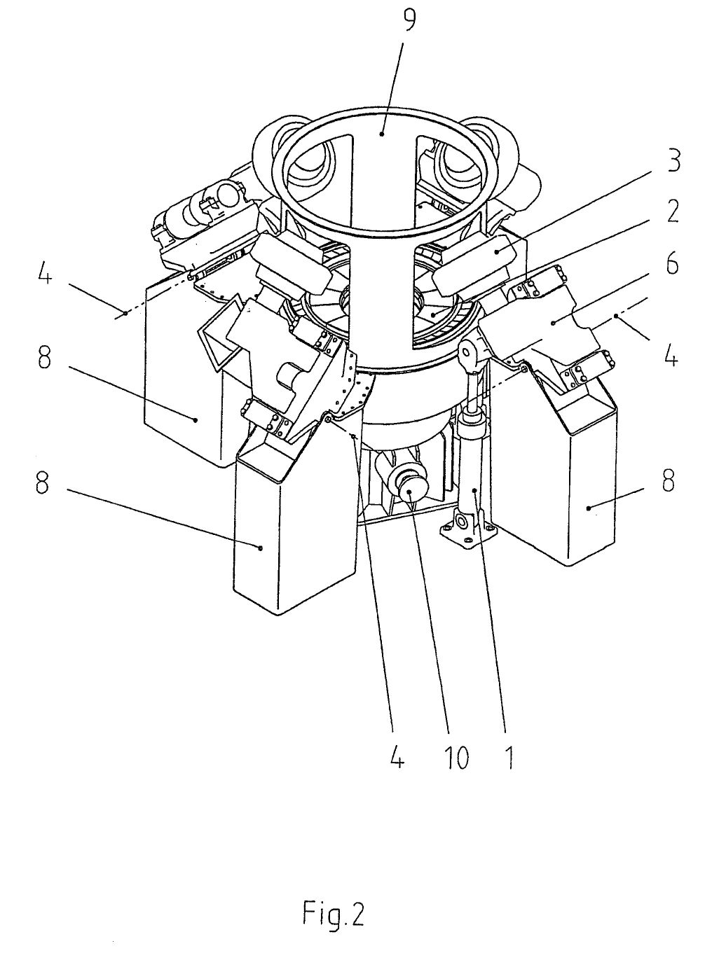

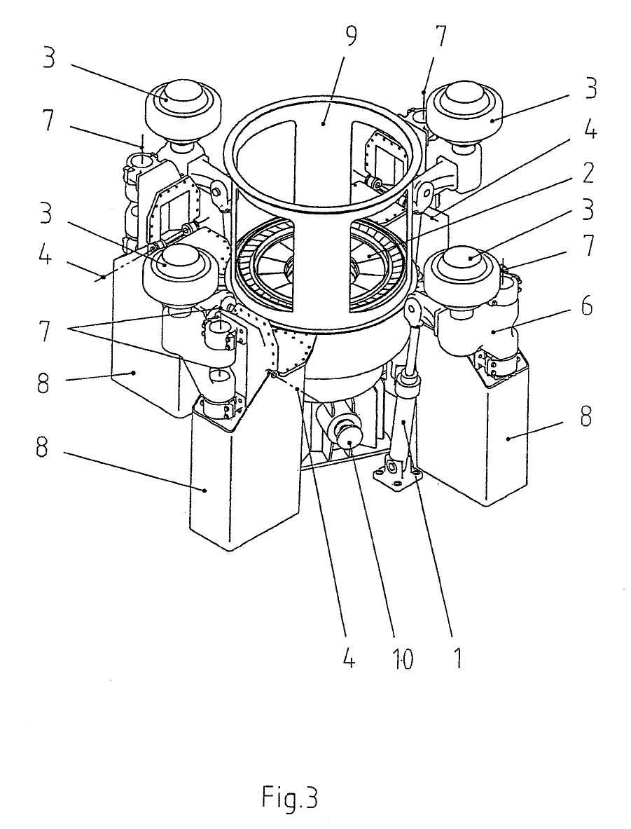

FIGS. 2 and 3 show the swiveling of the grinding rollers 3 out of the housing 9, for maintenance purposes, for example. For this purpose, swivel axes 4 that are each oriented perpendicular to the rocker axes 7 are provided between the brackets 8 and the rockers 6. In addition, the hydraulic cylinders 1 are positioned adjacent to the brackets 8. As a result of these measures, the grinding rollers 3 with their rockers 6 can be swiveled out of the mill housing 9 about their swivel axes 4 by extending the hydraulic cylinders 1. The hydraulic cylinder 1 remains engaged. The rocker axis 7 is simply locked and the swivel axis 4 is released. This means a considerable savings in work and time. The simplified—because guided—handling of the components, which weigh several tens of tons, also serves, not least, to improve workplace safety.

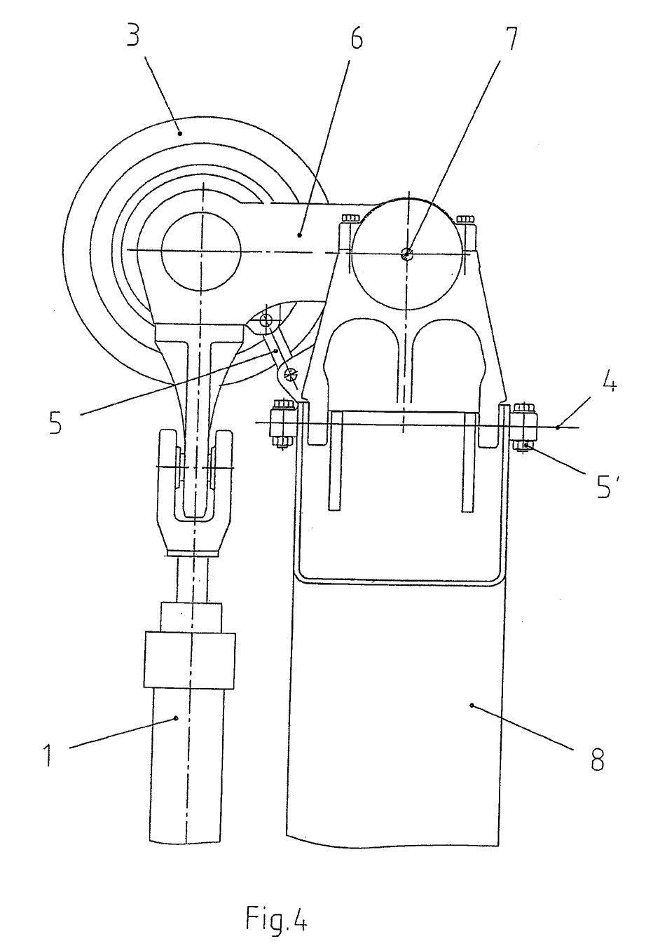

FIG. 4 shows an enlarged-scale view of a section of the roller mill from FIGS. 1 to 3 in the area of a rocker 6. The hydraulic cylinder 1 stands adjacent to the bracket 8 and is movably attached to the rocker 6 below the shaft of the grinding roller 3. A connecting rod 5 is placed between the rocker 6 and the rocker bearing. This locks the rocker axis 7 and, as a function of length, sets the position of the grinding roller 3 over the grinding track.

In addition, FIG. 4 shows that the swivel axis 4 can also be locked. Screw connections 5′ are provided for this purpose.

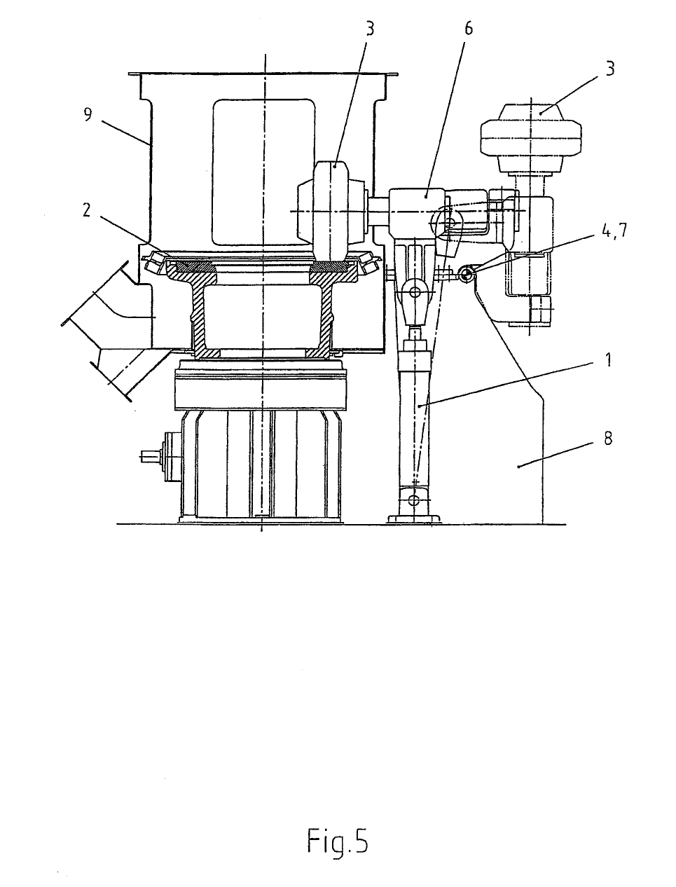

Lastly, FIG. 5 shows a cross-section through a second roller mill in which the swivel axis 4 and the rocker axis 7 are identical. This further simplifies the design. The clamping of the grinding rollers 3, and the raising of the grinding rollers 3 from the grinding track 2 for the purpose of starting the mill, as well as the swiveling of the grinding rollers 3 out of the mill housing 9, are carried out by appropriate control of the hydraulic cylinder 1.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A roller mill comprising:
a housing;
a grinding table having a drive;
grinding rollers configured to roll on the grinding table, the grinding rollers configured to be supported on brackets adjacent to the mill housing;
rockers and rocker axes provided for each grinding roller;
clamping devices with hydraulic cylinders configured to press the grinding rollers against the grinding table; and
a swiveling device with a swivel axis for each grinding roller,
wherein the hydraulic cylinders of the clamping devices are adjacent to the brackets, and
wherein the hydraulic cylinders of the clamping devices are configured to swivel the grinding rollers out of the housing.

2. The roller mill according to claim 1, wherein the swivel axis is oriented perpendicular to the rocker axis.

3. The roller mill according to claim 1, wherein removable connections alternately lock one of the axes.

4. The roller mill according to claim 1, wherein a removable connecting rod is provided to lock the rocker axis and/or to limit the travel of the grinding roller.

5. The roller mill according to claim 1, wherein screws are provided to lock the swivel axis.

8. The roller mill according to claim 1, wherein the rocker axis and the swivel axis are substantially identical.
